(19) United States
(12) Patent Application Publication
(10) Pub. No.: US 2004/0126626 A1
(43) Pub. Date: Jul. 1, 2004

(54) Luminescent fabric

(76) Inventor: Jen-Fu Chen, Feng Yuan City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/329,807

(22) Filed: Dec. 26, 2002

(51) Int. Cl. B32B 27/12; B32B 27/04

(52) U.S. Cl. 428/917; 442/2; 442/43

(57) ABSTRACT

A luminescent fabric includes a luminescent net and at least one filament woven onto the luminescent net. The luminescent net includes a first group of luminescent strips extending in a first direction and a second group of luminescent strips extending in a second direction. The second direction is perpendicular to the first direction. Each of the luminescent strips includes a body of a luminescent material and a pair of wires each including a portion embedded in the body and another portion exposed from the body for electric connection with a power supply. The luminescent net includes a first bus electrically connected in parallel with each of the luminescent strips of the first group and a second bus electrically connected in parallel with each of the luminescent strips of the second group. Each of the buses includes a body, a pair of trunk wires each including a portion embedded in the body and another portion exposed from the body for electric connection with a power supply and a plurality of pairs of branch wires each for electric connection between one of the trunk wires and one of the wires of one of the luminescent strips. Each of the branch wires includes a portion embedded in the body of the bus and electrically connected with one of the trunk wires and another portion exposed from the body of the bus for electric connection with one of the wires of one of the luminescent strips.

### BACKGROUND OF INVENTION

1. Field of Invention

The present invention relates to a luminescent fabric and, more particularly, to a fabric including a luminescent net and at least one filament woven on the net.

2. Related Prior Art

Various fabrics have been used to produce clothes, trousers, headgears, etc. These fabrics are printed with colors and/or patterns for aesthetic purposes. Reflective patches are sometimes attached to the fabrics for purposes aesthetics and/or safety. However, these reflective patches are useless regarding aesthetics and safety without an adequate external light source.

The present invention is therefore intended to obviate or at least alleviate the problems encountered in prior art.

### SUMMARY OF INVENTION

It is the primary objective of the present invention to provide a luminescent fabric.

According to the present invention, a luminescent fabric includes a luminescent net and at least one filament woven onto the luminescent net. The luminescent net includes a first group of luminescent strips extending in a first direction and a second group of luminescent strips extending in a second direction. The second direction may be perpendicular to the first direction. Each of the luminescent strips includes a body of a luminescent material and a pair of wires each including a portion embedded in the body and another portion exposed from the body for electric connection with a power supply.

The luminescent net may include a first bus electrically connected in parallel with each of the luminescent strips of the first group and a second bus electrically connected in parallel with each of the luminescent strips of the second group.

Each of the buses includes a body, a pair of trunk wires each including a portion embedded in the body and another portion exposed from the body for electric connection with a power supply and a plurality of pairs of branch wires each for electric connection between one of the trunk wires and one of the wires of one of the luminescent strips. Each of the branch wires includes a portion embedded in the body of the bus and electrically connected with one of the trunk wires and another portion exposed from the body of the bus for electric connection with one of the wires of one of the luminescent strips.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a cutaway front view of a luminescent fabric according to an embodiment of the present invention.

FIG. 2 is a block diagram of a circuit used in the present invention.

FIG. 3 is a front view of a portion of the luminescent fabric shown in FIG. 1.

FIG. 4 is a bottom view of the portion of the luminescent fabric show in FIG. 2.

FIG. 5 is similar to FIG. 2 but showing a portion of a luminescent fabric according to another embodiment of the present invention.

FIG. 6 is a perspective view of a jacket tailored from the luminescent fabric according to the present invention.

FIG. 7 is a perspective view of a purse tailored from the luminescent fabric according to the present invention.

FIG. 8 is a perspective view of a hat tailored from the luminescent fabric according to the present invention.

### DETAILED DESCRIPTION OF EMBODIMENTS

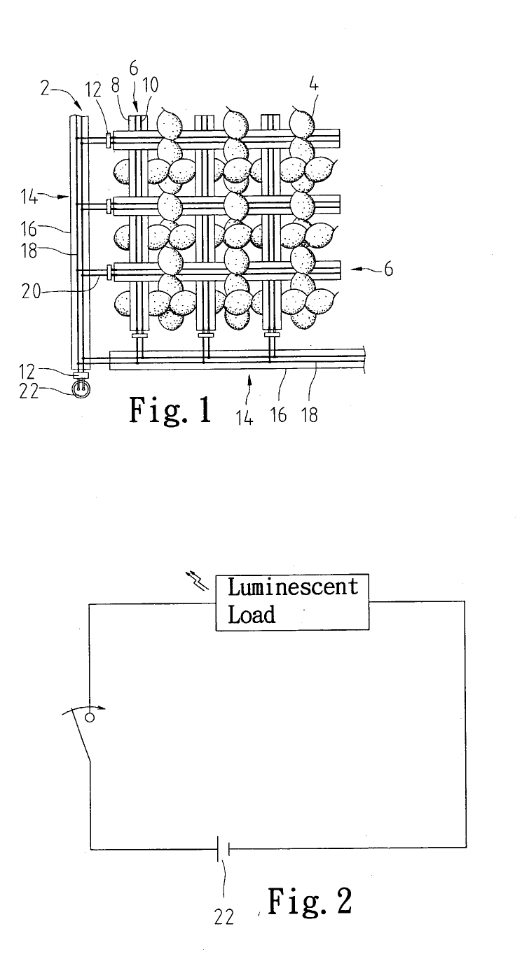

Referring to FIGS. 1-4, according to an embodiment of the present invention, a luminescent fabric includes a luminescent net 2 and at least one filament 4 woven onto the luminescent net 2.

The luminescent net 2 includes a first group of luminescent strips 6 extending in a first direction, a second group of luminescent strips 6 extending in a second direction perpendicular to the first direction, a first bus 14 and a second bus 14.

Each of the luminescent strips 6 includes a long flat body 8 of a luminescent material, a pair of wires 10 and a socket 12. For each of the luminescent strips 6, each of the wires 10 includes a portion embedded in the long flat body 8 and a another portion exposed from the long flat body 8 for operative connection with the socket 12.

Each of the buses 14 includes a long flat body 16 of a luminescent material, a pair of trunk wires 18 and a plurality of pairs of branch wires 20. For each of the buses 14, each of the trunk wires 18 includes a portion embedded in the long flat body 16 and a another portion exposed from the long flat body 16 for operative connection with a socket 12. Each of the trunk wires 18 of the first bus 14 is connected with one of the trunk wires 18 of the second bus 14. That is, the first bus 14 is electrically connected in parallel with the second bus 14. The socket 12 connected with the buses 14 can be engaged with a power supply 22.

For the first bus 14, each of the pairs of the branch wires 20 includes a portion embedded in the long flat body 16 and another portion exposed from the long flat body 16 for operative connection with the socket 12 of one of the luminescent strips 6 in the first group. That is, the first bus 14 is electrically connected in parallel with each of the luminescent strips 6 of the first group.

For the second bus 14, each of the pairs of the branch wires 20 includes a portion embedded in the long flat body 16 and another portion exposed from the long flat body 16 for operative connection with the socket 12 of one of the luminescent strips 6 in the second group. That is, the second bus 14 is electrically connected in parallel with each of the luminescent strips 6 of the second group.

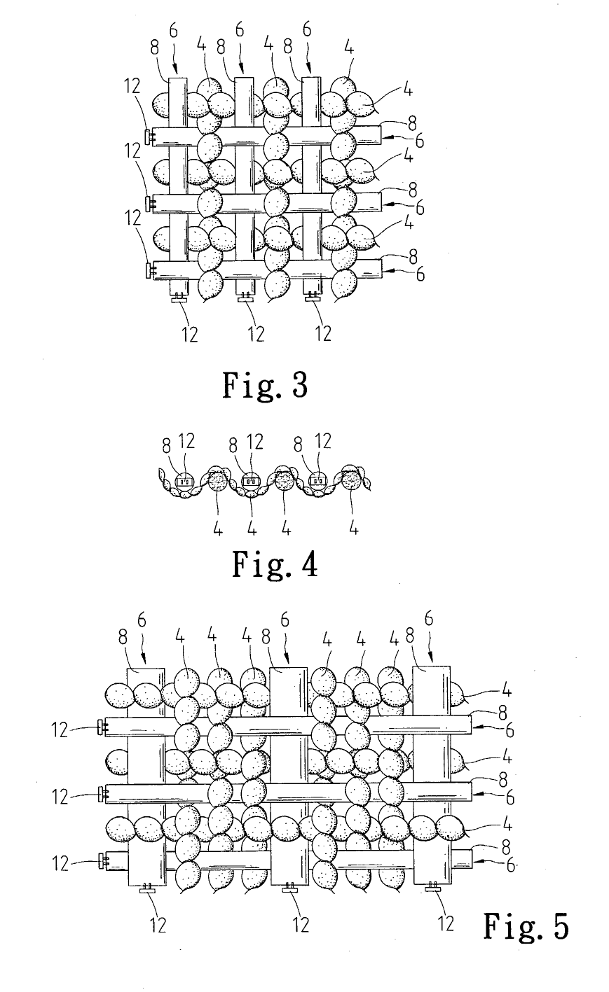

Referring to FIGS. 3 and 5, the first bus 14 is arranged parallel to the luminescent strips 6 of the second group. The second bus 14 is arranged parallel to the luminescent strips 6 of the first group.

Referring to FIG. 3, the luminescent strips 6 of the first group may simply be laid on the luminescent strips 6 of the second group. Adhesive may be provided between the first group and the second group for binding them.

Referring to FIG. 5, the luminescent strips 6 of the first group and the luminescent strips 6 of the second group may be woven. Adhesive may be provided between the first group and the second group for binding them.

The at least one filament 4 may be woven onto the luminescent net 2 in a manner shown in FIG. 3 or 5.

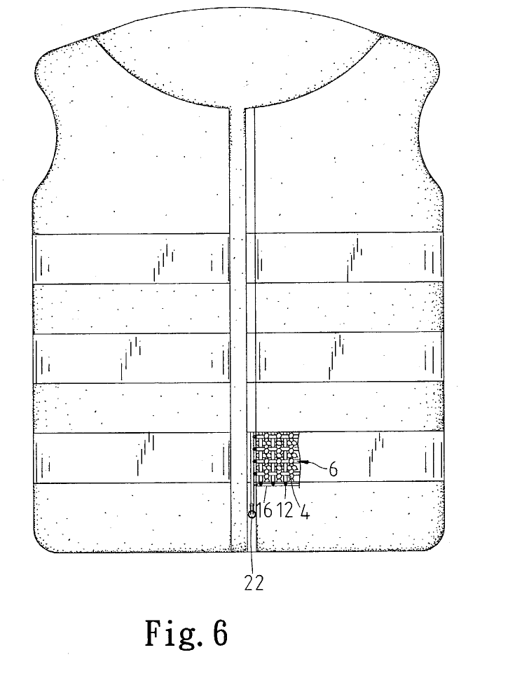

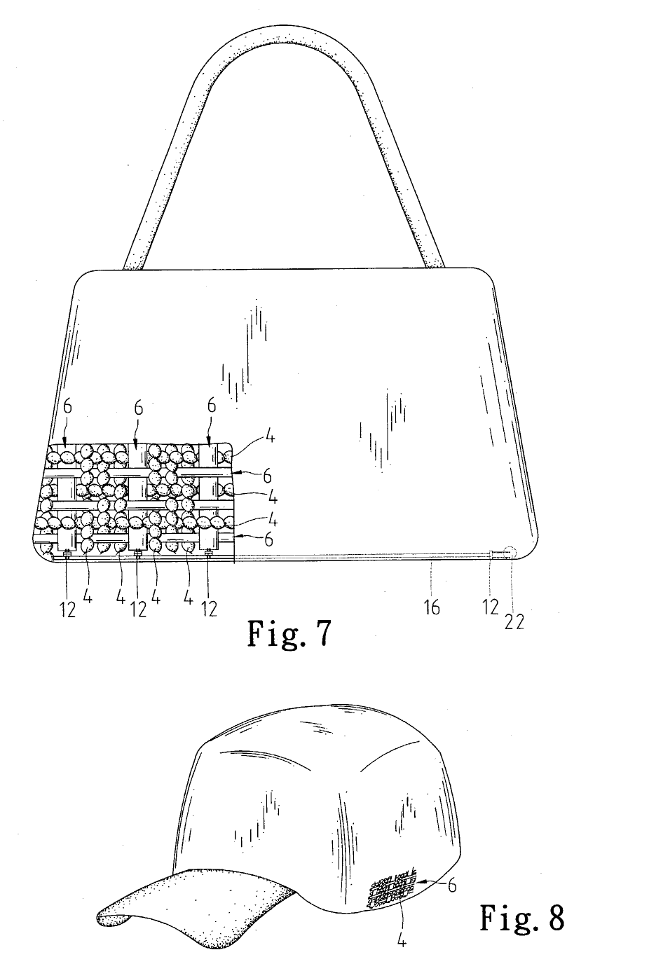

FIGS. 6-8 respectively show a jacket, a purse and a hat tailored from the fabric according to the present invention.

The present invention has been described through detailed illustration of embodiments. Those skilled in the art can derive many variations from the embodiments without departing from the scope of the present invention. Therefore, the embodiments shall not limit the scope of the present invention defined in the claims.

What is claimed is:

1. A luminescent fabric including a luminescent net and at least one filament woven onto the luminescent net.

2. The luminescent fabric according to claim 1 wherein the luminescent net includes a first group of luminescent strips extending in a first direction and a second group of luminescent strips extending in a second direction.

3. The luminescent fabric according to claim 2 wherein the second direction is perpendicular to the first direction.

4. The luminescent fabric according to claim 2 wherein each of the luminescent strips includes a body of a luminescent material and a pair of wires each including a portion embedded in the body and another portion exposed from the body for electric connection with a power supply.

5. The luminescent fabric according to claim 4 wherein each of the luminescent strips includes a socket electrically connected with the exposed portions of the wires.

6. The luminescent fabric according to claim 2 wherein the luminescent net includes a bus electrically connected in parallel with each of the luminescent strips of the first group.

7. The luminescent fabric according to claim 6 wherein each of the luminescent strips includes a body of a luminescent material and a pair of wires each including a portion embedded in the body and another portion exposed from the body for electric connection with a power supply, and the bus includes a body, a pair of trunk wires each including a portion embedded in the body and another portion exposed from the body for electric connection with a power supply and a plurality of pairs of branch wires each for electric connection between one of the trunk wires and one of the wires of one of the luminescent strips.

8. The luminescent fabric according to claim 7 wherein each of the branch wires includes a portion embedded in the body of the bus and electrically connected with one of the trunk wires and another portion exposed from the body of the bus for electric connection with one of the wires of one of the luminescent strips.

9. The luminescent fabric according to claim 7 wherein each of the luminescent strips includes a socket electrically connected with the exposed portions of the wires.

10. The luminescent fabric according to claim 7 wherein the body of the bus is made of a luminescent material.

11. The luminescent fabric according to claim 7 wherein the body of the bus is made of a luminescent material.

12. The luminescent fabric according to claim 2 wherein the luminescent net includes a bus electrically connected in parallel with each of the luminescent strips of the second group.

13. The luminescent fabric according to claim 12 wherein each of the luminescent strips includes a body of a luminescent material and a pair of wires each including a portion embedded in the body and another portion exposed from the body for electric connection with a power supply, and the bus includes a body, a pair of trunk wires each including a portion embedded in the body and another portion exposed from the body for electric connection with a power supply and a plurality of pairs of branch wires each for electric connection between one of the trunk wires and one of the wires of one of the luminescent strips.

14. The luminescent fabric according to claim 13 wherein each of the branch wires includes a portion embedded in the body of the bus and electrically connected with one of the trunk wires and another portion exposed from the body of the bus for electric connection with one of the wires of one of the luminescent strips.

15. The luminescent fabric according to claim 13 wherein each of the luminescent strips includes a socket electrically connected with the exposed portions of the wires.

16. The luminescent fabric according to claim 13 wherein the body of the bus is made of a luminescent material.

17. The luminescent fabric according to claim 13 wherein the body of the bus is made of a luminescent material.

18. The luminescent fabric according to claim 2 wherein the first group is laid on the second group.

19. The luminescent fabric according to claim 2 wherein the first group and the second group are woven.
